(19) United States
(12) Patent Application Publication
(10) Pub. No.: US 2019/0295088 A1
(43) Pub. Date: Sep. 26, 2019

(54) SYSTEM AND METHOD FOR EFFICIENT DETECTION OF FRAUD IN ONLINE TRANSACTIONS

(71) Applicant: Microsoft Technology Licensing, LLC, Redmond, WA (US)

(72) Inventors: Yuting Jia, Redmond, WA (US); Shoou-Jiun Wang, Sammamish, WA (US); Jayaram Nm Nanduri, Issaquah, WA (US)

(21) Appl. No.: 15/944,693

(22) Filed: Apr. 3, 2018

Related U.S. Application Data
(60) Provisional application No. 62/647,449, filed on Mar. 23, 2018.

(51) Int. Cl. G06Q 20/40; G06Q 30/06; H04L 29/08; G06N 5/04; G06F 15/18

(52) U.S. Cl. CPC G06Q 20/4016; G06Q 30/0601; G06F 15/18; G06N 5/04; H04L 67/22

(57) ABSTRACT

Methods, systems, and computer program products are provided for using pre-purchase scoring to efficiently detect fraud on an e-commerce platform. In particular, high dimension pre-purchase information may be consolidated into one or more scores to be carried over and applied to a real time machine learning model at the purchase stage. More specifically, a large amount of information is available, for example, when a user initially connects to the e-commerce platform, creates an account thereon, subsequently logs in using that account, or adds a payment instrument to their account. Such information is applied to a machine learning model that consolidates the information into a score to be carried over, and used further at the purchase stage.

### CROSS-REFERENCE TO RELATED APPLICATIONS

This application claims priority to U.S. Provisional Patent Application No. 62/647,449, filed Mar. 23, 2018, the entirety of which is incorporated by reference herein.

### BACKGROUND

Electronic commerce (“E-commerce”) is a form of commerce transacted online, generally via the Internet. E-commerce today is typically conducted over the World Wide Web using a personal computer, smart phone, a tablet computer, or other device that includes a web browser or other Internet-enabled application. The user of one of these devices can navigate to and connect to an e-commerce platform. An e-commerce platform is a form of network accessible system for transacting business, or otherwise providing services to users of the platform. The e-commerce platform enables on-demand access to goods and services online. An e-commerce platform typically consists of a shared pool of computing resources, such as computer networks, servers, storage, applications, and services, that can be rapidly provisioned to, among other things, serve webpages to users, and process user transactions. Notable examples of such e-commerce platforms include, Microsoft® Online Store, Xbox Live®, Amazon.com®, or eBay®.

After connecting to an e-commerce platform, a user may browse through product or service offerings shown thereon, and opt to purchase one or more of the offered products or services. As part of the transaction, the e-commerce platform solicits payment from the user, and the user typically provides credit card or other payment information to effect payment.

Just as with conventional “brick-and-mortar” establishments, however, credit card fraud can be a problem. Indeed, fraud and abuse in the e-commerce context is even more prevalent, due to the virtual presence of the transaction participants. Fraudsters can be physically located virtually anywhere in the world, and need not have a physical credit card or other payment instrument to commit a fraudulent transaction. Fraudsters can also take advantage of hijacked accounts, or other forms of identity theft, in addition to using stolen credit card information. In addition to credit card or other types of financial fraud, e-commerce platforms are also susceptible to other forms of fraudulent abuse as well. Such abuse can cause excessive consumption of storage, processing and human resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, and computer program products are provided that address issues related to fraud and abuse of an e-commerce platform or other system via which online transactions may be conducted. In one implementation, a fraud detection system of an e-commerce platform is enabled to collect behavior data related to user actions made via the user's account on the e-commerce platform. Behavior data is any information that can be associated with a particular user's account such as the user's device identification, the user's device IP address, the user's location and the like. Such behavior data is collected during all stages of use of e-commerce platform such as, for example, during account creation, at each login to the platform, adding a payment instrument to the account, or making a purchase.

Behavior data that is collected before a purchase or other transaction is attempted is used to generate features, and these features are input to a suitably trained machine learning fraud prediction model. The fraud prediction model outputs a fraud prediction score representing the probability of future fraudulent activity based on the collected behavior data. The fraud prediction score is then saved for later use during a purchase or other transaction, and the behavior data that was collected and used to produce the score may be discarded.

During a purchase or other subsequent transaction, the previously stored fraud prediction score is retrieved, and used as an input to a purchase-time fraud prediction model to generate a purchase-time fraud prediction score. The purchase-time fraud prediction model may also accept other features as input, including but not limited to spending history statistics associated with the user account. The generated purchase time fraud prediction score may then be used to predict whether the current transaction or purchase is fraudulent, and cancel the transaction or take other action as appropriate.

Further features and advantages of the invention, as well as the structure and operation of various embodiments, are described in detail below with reference to the accompanying drawings. It is noted that the embodiments are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for detecting fraudulent transactions on an e-commerce platform, according to an example embodiment.

FIG. 2 shows a flowchart of various stages of use of an e-commerce platform, according to an example embodiment.

FIG. 3 shows example behavior data collected by an e-commerce platform when one of the depicted example devices is used to access the platform, according to an example embodiment.

FIG. 4 shows additional data collected by an e-commerce platform that is associated with payment instruments and package shipment, according to an example embodiment.

FIG. 5 shows a flowchart of process steps during a signup stage of use of an e-commerce platform, according to an example embodiment.

FIG. 6 shows a flowchart of process steps during an add payment instrument stage of use of an e-commerce platform, according to an example embodiment.

FIG. 7 shows a flowchart of process steps during a purchase, start trial or start subscription stage of use of an e-commerce platform, according to an example embodiment.

FIG. 8 shows a flowchart of a method for determining a transaction is fraudulent based on historic user behavior patterns, according to an embodiment.

FIG. 9 is a block diagram of an example processor-based computer system that may be used to implement various embodiments.

The features and advantages of the present invention will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The present specification and accompanying drawings disclose one or more embodiments that incorporate the features of the present invention. The scope of the present invention is not limited to the disclosed embodiments. The disclosed embodiments merely exemplify the present invention, and modified versions of the disclosed embodiments are also encompassed by the present invention. Embodiments of the present invention are defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures described herein can be spatially arranged in any orientation or manner.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Embodiments described herein enable e-commerce platforms to monitor and record information related to a user's interactions with the e-commerce platform, and use such information to detect potential fraud or abuse in relation to subsequent transactions. Embodiments enable specific types of data to be gathered for transformation into features suitable for use with fraud detection machine learning models. Such fraud detection machine learning models may, for example and without limitation, produce a fraud risk score between 0 and 1 representative of the probability that some action may constitute fraud or abuse on the e-commerce platform. The risk score may then be saved for use during a subsequent stage of use of the e-commerce platform for predicting fraudulent or abusive activity.

For example, FIG. 1 shows a block diagram of a system 100 according to an example embodiment. System 100 includes a plurality of user devices 102A-102N, a network 104, and an e-commerce platform 106. Note that the variable “N” is appended to reference numerals for illustrated components to indicate that the number of such components is variable, with any value of 2 and greater. Note that for each distinct component/reference numeral, the variable “N” has a corresponding value, which may be different for the value of “N” for other components/reference numerals. The value of “N” for any particular component/reference numeral may be less than 10, in the 10s, in the hundreds, in the thousands, or even greater, depending on the particular implementation.

User devices 102A-102N include the computing devices of users (e.g., individual users, family users, enterprise users, governmental users, etc.) that access e-commerce platform 106 via network 104. Although depicted as a desktop computer, user devices 102A-102N may include other types of computing devices suitable for connecting with e-commerce platform 106 via network 104. User devices 102A-102N may each be any type of stationary or mobile computing device, including a mobile computer or mobile computing device (e.g., a Microsoft® Surface® device, a personal digital assistant (PDA), a laptop computer, a notebook computer, a tablet computer such as an Apple iPad™, a netbook, etc.), a mobile phone, a wearable computing device, or other type of mobile device, or a stationary computing device such as a desktop computer or PC (personal computer), or a server.

Network 104 may comprise one or more networks such as local area networks (LANs), wide area networks (WANs), enterprise networks, the Internet, etc., and may include one or more of wired and/or wireless portions.

E-commerce platform 106 includes Web server/transaction processor 108 and database 112. Web server/transaction processor 108 includes data collection component 110, fraud detection component 114 and score generation component 116. Although depicted as a monolithic component, Web server/transaction processor 108 may comprise any number of servers, and may include any type and number of other resources, including resources that facilitate communications with and between the servers, user devices 102A-102N, database 112, and any other necessary components both inside and outside e-commerce platform 106. Servers of Web server/transaction processor 108 may be organized in any manner, including being grouped in server racks (e.g., 8-40 servers per rack, referred to as nodes or “blade servers”), server clusters (e.g., 2-64 servers, 4-8 racks, etc.), or datacenters (e.g., thousands of servers, hundreds of racks, dozens of clusters, etc.). In an embodiment, the servers of Web server/transaction processor 108 may be co-located (e.g., housed in one or more nearby buildings with associated components such as backup power supplies, redundant data communications, environmental controls, etc.) to form a datacenter, or may be arranged in other manners. Accordingly, in an embodiment, Web server/transaction processor 108 may comprise a datacenter in a distributed collection of datacenters. Likewise, although depicted as a single database, database 112 of e-commerce platform 106 may comprise one or more databases that may be organized in any manner both physically and virtually. In an embodiment the servers of database 112 may be co-located in a manner like Web server/transaction processor 108, as described above.

Similarly, although score generation component 116 is depicted as being separate from database 112, it will be apparent to persons skilled in the art that operations of score generation component 116, and as described in further detail below, may be incorporated into, for example, database 112, or some other component. For example, score generation component 116 operations may be incorporated into a stored procedure of an SQL database, in an embodiment.

Operational aspects of system 100 will be discussed in some detail below. What follows immediately hereafter, however, is a discussion of the general operation of an embodiment of system 100. Using a browser on, for example, user device 102A, a user navigates to a URL associated with e-commerce platform 106, and establishes a connection therewith via network 104. At connection time, and at certain other times as described in more detail herein below, data collection component 110 of e-commerce platform 106 actively collects behavior data associated with the user's interaction with e-commerce platform 106, and may optionally store such behavior data in database 112 depending on the stage of use of e-commerce platform 106. If the behavior data is saved for later use, it is typically stored in association with an account ID, device ID or some other useful means for associating the behavior data with a particular user or user account, and to facilitate later retrieval. In one embodiment, for example, data collection component 110 may note the IP address and IP address geolocation (i.e. the geographic location on earth of the IP address in question) of user device 102A, and store that information in database 112 in association with an identifier of the relevant user account. As will be discussed in more detail below, however, storing all behavior data at all times may not be advantageous, and instead, such data can be distilled down to a single score for later use. Also, terms like “collect” or “capture” are used throughout the detailed description in reference to behavior data. It should be understood that these terms are interchangeable and mean to “receive” or otherwise “obtain” behavior data.

In an embodiment, score generation component 116 obtains the behavior data, creates features from that data, and inputs the features to a suitably trained machine learning fraud detection model. The output of the fraud detection model is a fraud risk score that represents a probability or likelihood that a subsequent transaction or other action is fraudulent. In one embodiment, the probability or likelihood is represented as a value between zero and one, although other scoring schemes or metrics may be utilized. Score generation component 116 is further configured to store the fraud risk score in database 112 for later use. In an embodiment, the behavior data collected by data collection component 110 and provided to score generation component 116 is not stored in database 112 after it has been used to generate the fraud risk score for a particular user account. That is to say, such behavior data may be deleted after generation of the fraud risk score for a particular user account to conserve resources of e-commerce platform 106 as will be discussed below.

At a later time, when the user attempts to execute a transaction during a session such as a purchase on e-commerce platform 106, score generation component 116 may create new features from more recently gathered behavior data. In an embodiment, for example, the new features may be generated from behavior data collected during the current session. In an example embodiment, score generation component 116 may also create features based on historical spending statistics of the user. Score generation component 116 also retrieves the previously stored fraud risk score from database 112. Score generation component 116 then inputs any newly generated features, and the retrieved fraud risk score to a suitably trained machine learning fraud detection model, the output of which is a purchase-time fraud risk score. In an embodiment, the fraud detection model may be obtained using a same or similar machine learning technique as was used to obtain the model that produced stored fraud risk score. In other embodiments, however, different machine learning techniques may be used to produce the different models. The purchase-time fraud risk score may represent the probability that the current transaction is fraudulent.

Fraud detection component 114 is configured to accept the purchase-time fraud risk score, and determine based at least on such score how the current transaction should be handled. For example and without limitation, fraud detection component 114 may completely block the transaction, may perform additional fraud analysis to augment the purchase-time fraud risk score, or may flag the transaction for further review.

Note that foregoing general description of the operation of system 100 stands as one example only, and embodiments of system 100 may operate in a manner different than described above. Furthermore, not all such processing steps need be performed in all embodiments. What follows is discussion of the remaining figures wherein detailed operational specifics of various embodiments of system 100 will be apparent.

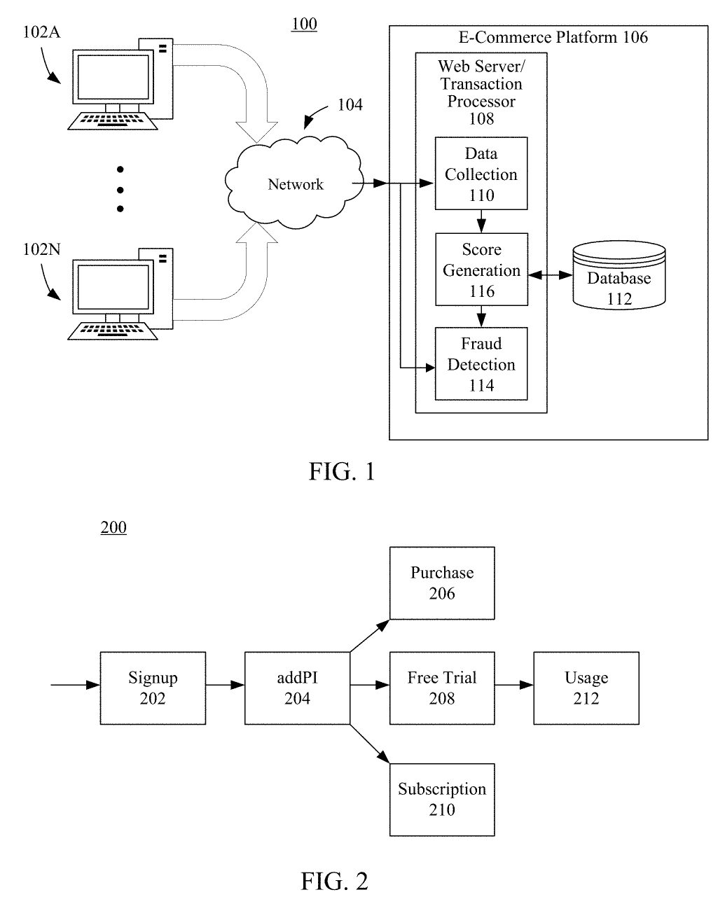

In embodiments, e-commerce platform 106 of system 100 may be used in various ways by a user. For instance, FIG. 2 shows a flowchart 200 of typical stages of use of e-commerce platform 106, according to an example embodiment. Although many e-commerce platforms permit people to use certain aspects of the platform without creating an account or otherwise signing up (e.g. browsing through and/or searching for products or services on the platform), any sort of transaction typically requires the user to create an account as depicted in signup stage 202 of FIG. 2. At this stage, the user generally provides at least an email address and password they wish to use with e-commerce platform 106, and may be asked to provide more information depending on the particulars of the platform.

In an embodiment, the next stage of use of e-commerce platform 106 requires the user to associate a payment instrument with their account at addPI (which means “add payment instrument”) stage 204. In other embodiments, however, e-commerce platform 106 may not require the user to enter payment instrument information until a later stage, such as checkout. In flowchart 200, however, it is assumed the addPI stage is required prior to entering one or more of transaction stages 206, 208 or 210. In an embodiment, at addPI stage 204, the user enters, for example, a credit card number, expiration date of the credit card, and the CVV value associated with that card, and e-commerce platform 106 saves that information to the user's account. In another embodiment, the user may instead enter information associated with a gift card or gift certificate, or establish some other means of paying for goods and services such as providing bank account and ACH routing numbers.

After adding a payment instrument to the account, process flow may continue to one or more of transactions stages 206, 208 or 210 in flowchart 200. In particular, the user may elect to make a purchase 206, start a free trial 208 or start a subscription 210. A purchase 206 is generally associated with the procurement of goods such as books or other merchandise including downloadable merchandise such as software, music or movies. A free trial 208 or subscription 210, by contrast, is generally associated with a service provided by or in association with e-commerce platform 106. For example, Microsoft® Xbox Live® is an online multiplayer gaming and digital media delivery service. A subscription to Xbox Live® is required to participate in many popular online multiplayer games. Subscriptions services like Xbox Live® are often offered on a free trial basis allowing users to evaluate the usefulness and value of the service prior to signing up for a subscription. Bearing this example in mind, after addPI stage 204, a user may enter free trial stage 208 to signup up for a free trial of the service. Alternatively, or perhaps sometime after free trial stage 208, the user may elect to pay for a subscription at subscription stage 210. Naturally, usage stage 212 would follow any of purchase stage 206, free trial stage 208 or subscription stage 210. That is, the service or product is bought or subscribed to in one or more of transaction stages 206, 208 or 210, is used or otherwise consumed in usage stage 212.

At each of stage 202-212, embodiments may capture, collect, receive or otherwise obtain behavior data associated with each stage or transaction, generate a fraud risk score based at least in part thereon, and store the fraud risk score (in, e.g., database 112) for use in detecting fraud during a subsequent transaction. For example, and as discussed briefly above, e-commerce platform 106 of FIG. 1 may capture the IP address and IP address geolocation of user device 102A during each stage of use depicted in flowchart 200. It should be understood, however, that the IP address and IP address geolocation of are only two examples of user behavior data that may be collected by e-commerce platform 106. It should likewise be understood that behavior data that is collected does not necessarily correspond to a particular user, but rather the use of a particular account. Indeed, embodiments may detect fraudulent activities with, for example, a hijacked account where the “user” is not the owner of the account, but a fraudster at some other location.

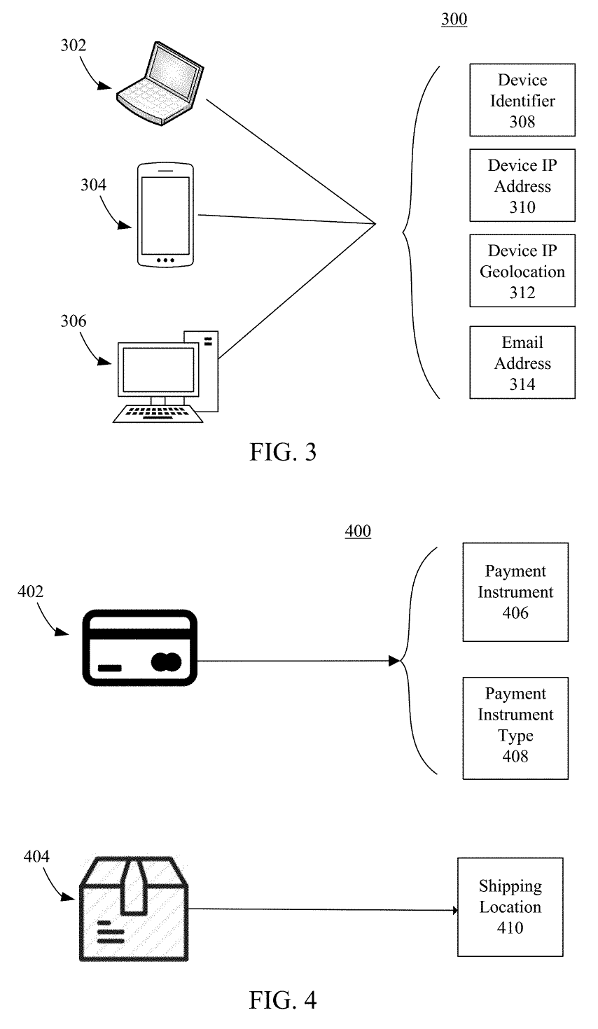

As described above, e-commerce platform 106 may collect many types of user behavior data. For instance, FIGS. 3 and 4 show additional example user behavior data that may be collected in one or more embodiments. Referring now specifically to FIG. 3, user devices 302, 304, and 306 illustrate varying means by which a user may connect to e-commerce platform 106. As discussed above, a user may connect to e-commerce platform 106 using, for example, a laptop 302, a smart phone 304, or a desktop computer 306. At connection time, and during any stage of use depicted in flowchart 200, data collection component 110 may collect and store any of user behavior data 308 through 314. In an embodiment, the behavior data may be stored in database 112 of system 100 as discussed above.

Device identifier 308 as depicted in FIG. 3, is behavior data that uniquely identifies the device used to connect to e-commerce platform 106. Device identifier 308 can be used to determine, for example, whether the user has connected using laptop 302, or smart phone 304 even where all other usage data collected in different sessions or stages is otherwise identical. Device identifier 308 is synonymous with “device fingerprint” or “machine fingerprint,” as known in the art. Various means of generating a unique device identifier 308 are likewise known in the art.

Device IP address 310 is simply the IP address of the user device used to connect to e-commerce platform 106. Likewise, device IP geolocation 312 is an estimate or identifier of a geographic location of device IP address 310 as known in the art.

Lastly, whenever any user action taken on e-commerce platform 106 can be accurately associated with an email address 314, that behavior data is also collected. Indeed, each of the stages of use after signup stage 202 depicted in flowchart 200 of FIG. 2 may require the user to login to his/her account having an email address associated therewith. Changes to the associated email address 314 would be reflected in collection of behavior data during later transactions.

We turn now to FIG. 4 that shows additional example behavior data that may be collected in one or more embodiments. More specifically, credit card 402 illustrates an example payment instrument in an embodiment. During addPI stage 204 as discussed above, e-commerce platform 106 may collect and optionally save behavior data associated with payment instrument 406 and payment instrument type 408. For example, behavior data associated with payment instrument 406 may include a credit card number, expiration date, CVV number, billing address, billing phone number and so forth as is typically required for e-commerce or telephone based credit card transactions. Where payment instrument 406 is associated with a credit card, payment instrument type 408 will reflect that fact. In an embodiment, and where payment instrument 406 is, for example, a credit card, payment instrument type 408 may indicate the type of credit card. In other embodiments, payment instrument 406 and payment instrument type 408 may comprise data associated with a gift certificate, a PayPal® account, an EFT/ACH routing number and checking account number, or any other means of paying for goods and services. FIG. 4 also depicts package 404 representing merchandise to be shipped to a specific address. Where the user purchases physical goods that require delivery, a shipping address is of course required. One or more embodiments may save shipping location 410 as behavior data. In so doing, e-commerce platform 106 can track the shipping history of a customer and readily detect changes to the delivery address that may signify fraud.

It is noted that the types of behavior data collected by e-commerce platform 106 should not be limited to those depicted in FIGS. 3 and 4, and as discussed above. Instead, behavior data may include any type of data or information associated with user actions conducted via a user account of an e-commerce system. For example, behavior data may also include information such as the address associated with a particular payment instrument, the age of the user's account, the user's purchase history and or statistics derived therefrom, or how frequently the user uses the account.

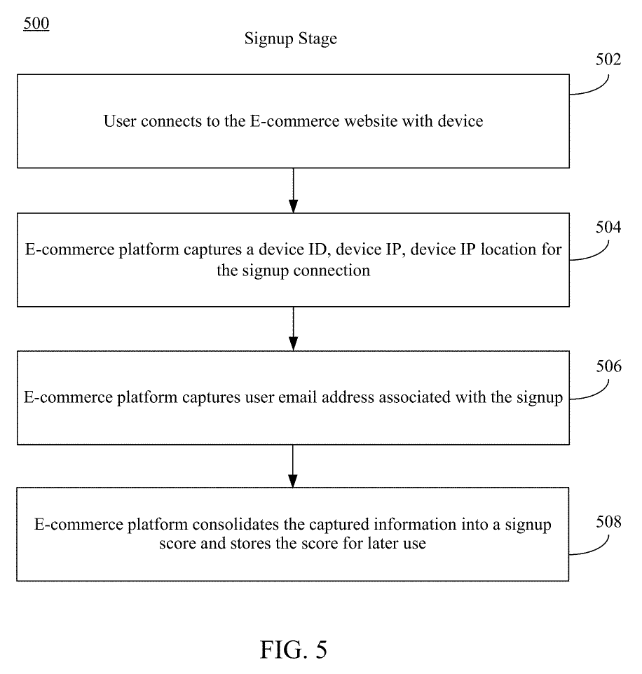

As discussed in part above, in one or more embodiments, e-commerce platform 106 may collect behavior data associated with user actions conducted via their account on e-commerce platform 106. Such actions may, for example, occur during the stages of use as depicted in FIG. 2 and discussed above. For instance, FIGS. 5-8 depict flowcharts 500-800, respectively, illustrating the process for collecting behavior data during the stages of use shown in FIG. 2, as well as examples of such behavior data. Note that the steps of flowcharts 500-800 may be performed in an order different than shown in some embodiments. Furthermore, not all steps of flowcharts 500-800 need to be performed in all embodiments. Further operational embodiments will be apparent to persons skilled in the relevant art based on the following descriptions of flowcharts of 500-800.

Flowchart 500 of FIG. 5 shows a process for collecting behavior data during sign-up stage 202 as shown in FIG. 2. Flowchart 500 begins with step 502. In step 502, a user connects to e-commerce platform 106 with a device. For example, a user may use a web browser or other Internet-enabled application on a suitable device to navigate to a URL associated with e-commerce platform 106. Continuing to step 504, even before the user takes any action after connecting to e-commerce platform 106 (but also during or after), e-commerce platform 106 can capture behavior data such as a device ID, device IP, and device IP location associated with the user's device for that connection and store it (e.g., in database 112 or other suitable storage medium). In an embodiment, e-commerce platform 106 may store such behavior data in a cookie stored on the user's device for later retrieval and processing by e-commerce platform 106 during the user's subsequent connections to the platform. Such an embodiment may usefully permit e-commerce platform 106 to track use of the platform even when the user actions are not taken in conjunction with a particular account (e.g. browsing without first logging in).

In step 506, embodiments of e-commerce platform 106 capture and store (e.g., in database 112 or other suitable storage medium) a user email address associated with the user, as entered during the sign-up process. In other embodiments, e-commerce platform 106 may also capture other relevant and useful information associated with the user as provided by the user during the sign-up process.

At step 508, e-commerce platform 106 uses all captured behavior data and other information, to produce a sign-up fraud risk score. The sign-up fraud risk score is a type of fraud score produced by a machine learning fraud model as will be discussed in more detail below. In an embodiment, e-commerce platform 106 transforms some or all of the captured behavior data into features suitable for input to the fraud model. The output of the fraud model, the sign-up fraud risk score, is then stored for later use by e-commerce platform 106 in, for example, database 112. At the conclusion of the sign-up stage, e-commerce platform 106 may then discard some or all of the collected behavior data thereby saving storage resources, as well as computational resources that would otherwise be consumed during later stages of use of e-commerce platform 106.

After signup stage 202 of FIG. 2 is complete, a user may login to the newly created account. Indeed, this may happen any number of times for a variety of reasons. In an embodiment, e-commerce platform 106 may capture one or more of device ID, device IP address or device IP geolocation, in addition to other relevant behavior data. In an embodiment, e-commerce platform 106 may use score generation component 116 to generate a login fraud risk score based on the collected behavior data every time the user logs in to the account. The process for generating such a login fraud risk score is as detailed above. Each generated login fraud risk score is likewise stored by e-commerce platform 106 for determining whether a subsequent transaction is fraudulent. However, before the user can complete a transaction on e-commerce platform 206, the user must add a payment instrument to his or her account.

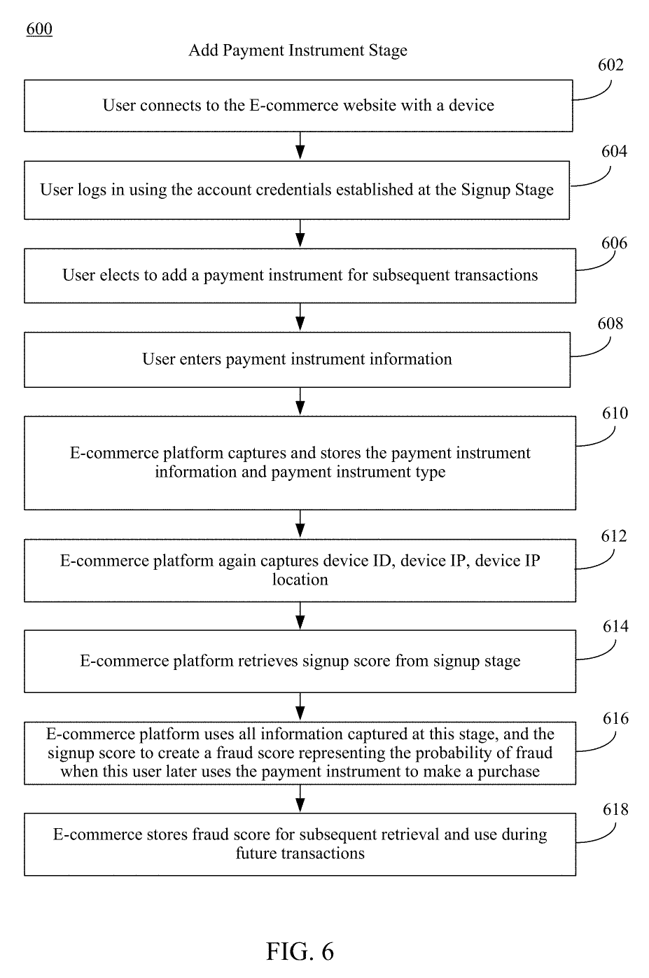

An example process for collecting behavior data during the add payment instrument (“addPI”) stage 204 of FIG. 2 is shown in flowchart 600 of FIG. 6. Flowchart 600 begins with step 602. In step 602, a user connects to e-commerce platform 106 with a device. This may be accomplished through the use of a web browser or other Internet-enabled application as discussed above. At step 604, the user logs in using the account credentials established at sign-up stage 202. Assuming that the user wishes to transact business on e-commerce platform 106, the user elects to add a payment instrument for subsequent transactions at step 606. The user is now required to provide payment instrument information at step 608. This may be accomplished by the user providing credit card information as discussed above. Flowchart 600 continues at step 610 where e-commerce platform 106 stores payment instrument information and payment instrument type also as discussed above.

Flowchart 600 continues at step 612, with e-commerce platform 106 again capturing the device ID, device IP, and device IP geolocation of the user's device. At step 614, e-commerce platform 106 retrieves the previously stored sign-up fraud risk score generated during the sign-up stage 202. In another embodiment, e-commerce platform 106 may also retrieve one or more login fraud risk scores that were previously generated and stored by e-commerce platform 106.

Flowchart 600 continues at step 616 where e-commerce platform 106 generates an addPI fraud risk score. Again, as discussed above, e-commerce platform 106 may direct score generation component 116 to transform any available behavior data into features suitable for use as input to a machine learning fraud risk scoring model. In addition to the generated features, score generation component 116 may input the retrieved sign-up score, and in another embodiment, one or more retrieved login fraud risk scores to the machine learning model. It should be understood, however, that use of signup or login fraud risk scores for generating the addPI fraud risk score if optional. The machine learning model thereby generates an addPI fraud risk score. At step 618, e-commerce platform 106 stores the addPI fraud risk score for later use. In an embodiment, e-commerce platform 106 need not store or otherwise maintain any of the behavior data collected during the addPI stage (except in as much as may be necessary for performing subsequent transactions, e.g., the user's credit card information).

Note that the steps of flowchart 600 may be performed in an order that is different than shown in some embodiments. For example, the behavior data captured at step 612 may instead be captured earlier in the process flow. Indeed, such behavior data can be captured at any time including before the user has had an opportunity to log in to e-commerce platform 106.

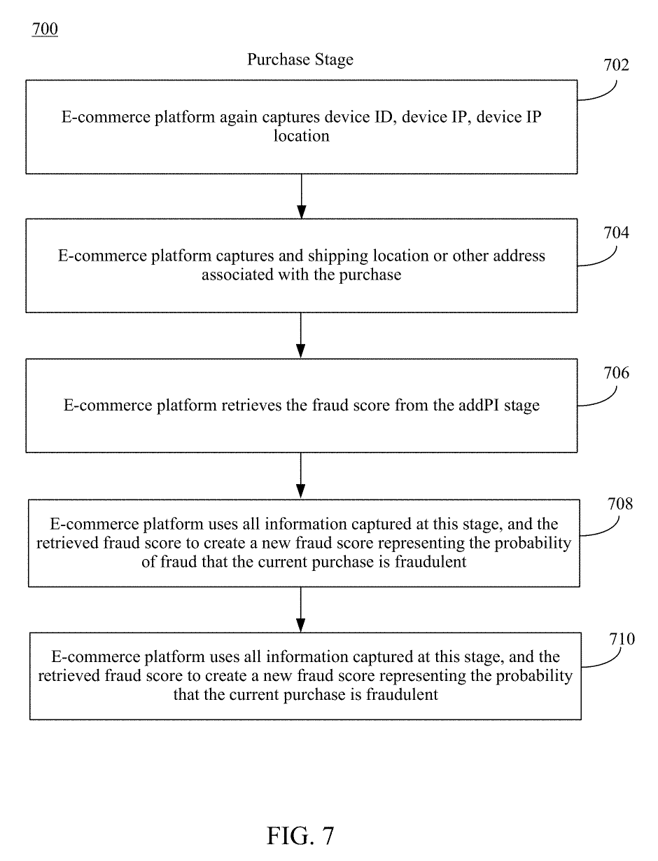

As discussed above, e-commerce platform 106 may collect behavior data during any of purchase stage 206, free trial stage 208, or subscription stage 210 as shown in FIG. 2. Flowchart 700 of FIG. 7 shows a process for collecting such behavior data, and for using one or more of the previously stored fraud risk scores for predicting whether the current transaction is fraudulent. Flowchart 700 begins at step 702. Step 702 shows that e-commerce platform 106 may, in some embodiments, capture behavior data comprising any or all of a device ID, a device IP, and a device IP geolocation. At step 704, and assuming that the user action requires the user to provide a shipping location, e-commerce platform 106 captures and stores behavior data reflecting such shipping address or other associated address. In an embodiment, e-commerce platform 106 may also calculate and/or update purchase statistics for the user account at step 704. That is, for example, e-commerce platform 106 may compute the total amount spent and number of transactions over the past 1 day, 7 days, 1 month, 3 months, or other time period as appropriate. One of skill in the art will recognize, that steps 702 and 704 of flowchart 700 may be performed in any order.

Flowchart 700 continues at step 706. Step 706 shows that e-commerce platform 106 retrieves the addPI fraud risk score generated at the addPI stage as discussed above. In other embodiments, e-commerce platform 106 may also retrieve some or all of the previously stored sign-up fraud risk score and/or login fraud risk scores. E-commerce platform 106 thereafter generates features from any available behavior data that may have been captured during the purchase stage. The generated features, and the retrieved sign-up fraud risk score and/or login fraud risk scores are then input to another machine learning model by, for example, score generation component 116. The output of the machine learning model, is a score representing the probability that the current purchase is fraudulent, which may also be referred to herein as a purchase-time fraud risk score. It should be noted that in an embodiment, the behavior data collected at addPI stage 204, and as discussed above in conjunction with FIG. 6, is not used to calculate the purchase-time fraud risk score. Indeed, it is easier and conserves considerable resources to carry over only the addPI fraud risk score calculated at addPI stage 204 for use at the purchase stage.

In another embodiment, e-commerce platform 106 may also provide purchase history statistics to the machine learning model, or use such statistics in conjunction with the purchase-time fraud risk score. Such statistics reflect the user's overall spending patterns, and in particular, whether and how much prior purchase activity resulted in chargebacks or other fraud outcomes. For example, e-commerce platform 106 may, for each user account, generate statistics related to “good” and “bad” transactions by the user account, and store such statistics in, e.g., database 112 of FIG. 1. In this context, a “bad” transaction is one in which there was confirmed fraud, or a chargeback or other negative financial consequence for the e-commerce platform provider. A “good” transaction, on the other hand, is simply a transaction for which there is no confirmed fraud, chargeback or other negative financial consequence for the e-commerce platform provider.

The purchase history statistics may include things such as a date of a last bad transaction, a raw number of good transactions and bad transactions and/or a number of dollars spent in good transactions (hereinafter “good dollars”) and bad transactions (hereinafter “bad dollars”). More advanced statistics may also be beneficially generated and stored. For example, e-commerce platform 106 may compute a pure dollar amount for the account, where the pure dollar amount is simply (good dollars-W*bad dollars), where W is a penalty weighting. In an embodiment, the penalty weighting W is greater than 1 so that bad dollars count more than good dollars in assessing fraud risk.

In an embodiment, e-commerce platform 106 may also compute a decayed pure dollar statistic. The principle underlying the decayed pure dollar statistic is that more recent activity, whether good or bad, ought to be weighted more heavily. Said another way, older activity should have less weight. Accordingly, decayed pure dollars includes an exponential decay factor as follows: decayed pure dollar=SUM((good dollars−W*bad dollars)*exp(−delta t/T)). Here, T is a preselected decay constant that may be for example 60, 180 or 365 days. Delta t is the duration in days from the past purchase date to the current date.

In another embodiment, the purchase-time fraud risk score generated at purchase time, as discussed above, may be used to decide how much weight to give more recent transactions. To compute such a statistic, which may be referred to as the adjusted pure dollar amount, e-commerce platform 106 can compute and sum the ordinary pure dollar statistic as discussed above for each transaction older than for example 3 months, and sum that value of settled transactions in the last 3 months weighted by a parameter that depends on the purchase-time fraud risk score. Adjusted pure dollar statistic can be computed as follows:

Adjusted pure dollar=SUM(good dollar−W*bad dollar)[for transactions older than90 days]

SUM((settled amount)*(1−(W+1)*Score*exp(−k*delta_t/90))[transactions within 90 days]

Here, “settled amount” is the bank approved purchase amount of each transaction in the last 90 days, W and delta t are as defined above and “Score” is the purchase-time fraud risk score, which represents the probability of fraud, generated at purchase time. Some or all of the above described purchase history statistics may be used as features input to a machine learning fraud risk model for better predicting the risk associated with a given action or transaction.

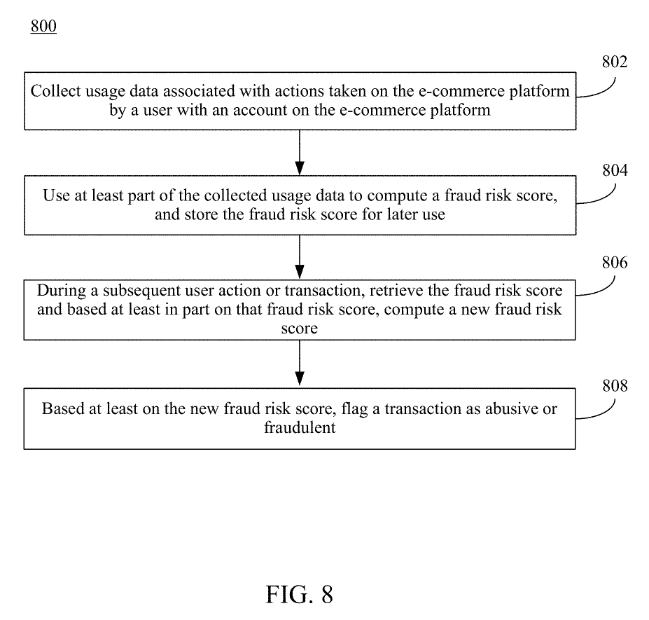

In embodiments, e-commerce platform 106 of system 100 may operate in various ways to detect fraudulent transactions. For instance, FIG. 8 shows a flowchart 800 of a method for detecting fraud in e-commerce platform 106 of system 100 in one embodiment. Note that the steps of flowchart 800 may be performed in an order different than shown in FIG. 8 in some embodiments. Furthermore, not all steps of flowchart 800 need to be performed in all embodiments.

Flowchart 800 begins at step 802. In step 802, e-commerce platform 106 may collect behavior data associated with actions taken by a user with a user account on e-commerce platform 106. Such actions in step 802 may comprise one or more of, signing up for the user account, logging into the account, adding a payment instrument to the user account, making a purchase with the user account, starting a free trial with the user account, or starting a subscription with the user account. The behavior data collected by e-commerce platform 106 may comprise any of a device identifier, a device IP address, and device IP address geolocation, an email address, a payment instrument, a payment instrument type, a payment instrument address, the age of the account, the purchase history associated with the account, the frequency of use of the account, or a shipping location.

Flowchart 800 continues at step 804. In step 804, one or more components of e-commerce platform 106 compute behavior features based on the behavior data. Using the computed behavior features, e-commerce platform 106 computes a fraud risk score by inputting such features to a suitably trained machine learning model. The output of the model is a fraud risk score that represents the probability that any subsequent action or transaction constitutes abuse or fraud. E-commerce platform 106 stores the fraud risk score at step 804. However, e-commerce platform 106 may discard some or all of the behavior data used to create the fraud risk score.

At step 806 of flowchart 800, e-commerce platform 106 is used with the user account to attempt a transaction, and embodiments attempt to detect and prevent fraudulent activity. To accomplish this, e-commerce platform 106 computes a new fraud risk score based on any available behavior data (after first being transformed to suitable features), and based on the fraud risk score previously stored at step 804 as discussed above. After retrieving the stored fraud risk score, e-commerce platform 106 inputs any new behavior features and/or purchase history features and the retrieved fraud risk scores from pre-purchase stages to a suitably trained machine learning fraud risk model. In an embodiment, that portion of step 806 may be performed by score generation component 116 of e-commerce platform 106 as depicted in FIG. 1. In one embodiment, the fraud risk model may be a machine learning model such as a gradient boosting decision tree, an artificial neural network, a deep neural network or some other type of machine learning classifier. Accordingly, the disclosed embodiments are not limited to any particular type of fraud risk model employed by, for example, score generation module 116 of e-commerce platform 106.

At step 808 of flowchart 800, e-commerce platform 106 uses the newly generated fraud risk score at least in part to determine whether the pending transaction may be fraudulent and take appropriate steps such as, for example, cancelling the transaction.

The foregoing systems and methods enable the detection of fraud in online transactions to be carried out accurately and in a manner that leverages data collected over various stages of user interaction with an e-commerce platform, but without the necessity for storing the collected data for later use. Instead, only a fraud score derived from the collected data is carried over from stage to stage thus conserving computational and storage resources. Responsive to detection of a fraudulent transaction, the e-commerce system can take any number of actions, including but not limited to, generating an alert, halting or terminating a transaction, cancelling a user account, flagging a transaction as fraudulent, or the like. The systems and methods described herein can greatly improve the performance of the various computers that make up an e-commerce platform by, for example, reducing the processing and storage associated with fraudulent online transactions by halting such transactions before they can be carried out or by deactivating accounts that are deemed to be fraudulent.

Furthermore, although much of the foregoing discussion is couched in terms of a transaction being a financial transaction such as purchase, it should be understood that “transaction” may comprise many other types of activities that a user might undertake with a user account on e-commerce platform 106 or other system. Some such activities may comprise fraudulent or abusive behavior. Embodiments may usefully detect and prevent such abuse.

For example, some e-commerce platforms permit users to write and publish reviews or other feedback about goods or services obtained through the e-commerce platform. It is not uncommon, however, for people to try and game the review system in by publishing a number of fake, glowing reviews of a product. This is typically done to boost sales of a product, but sometimes a vendor on an e-commerce platform may publish fake reviews to attempt to offset other, very negative reviews of their product that were published by other users. Clearly, the reputation of an e-commerce platform may be damaged if it permits such abuse.

Beyond reputation and financial considerations, however, permitting such abuse can undermine the efficiency of the e-commerce platform itself. In the “fake review” example discussed above, such reviews are typically authored and published by a fake account. That is, an account created specifically for the purpose of undertaking abusive activity, and not for any bona fide use of the e-commerce platform. This is true for many types of abusive activity, not just publishing fake reviews. For example, a person may create many accounts again and again in order to continually take advantage of a free trial offered on the e-commerce platform. All of these abusive activities, whether posting fake reviews or creating numerous fake accounts and the like, consume tremendous amounts of storage and processing power. Automated processes for policing non-financial activities are likewise costly in terms of storage and processing. Accordingly, it should be understood that a “transaction” in the context of embodiments of the invention includes non-financial activities, and embodiments may usefully be configured to detect such fraudulent or abusive activities.

Furthermore, although the foregoing detailed description discusses embodiments in the context of e-commerce platforms, it should be understood that embodiments are not limited to e-commerce platforms. Embodiments of the invention may be applied to any type of system that supports online transactions of any kind.

### III. Example Computer System Implementation

User device(s) 102A-102N, web server/transaction processor 108, score generation component 116, fraud detection component 114, data collection component 110, flowchart 500, flowchart 600, flowchart 700 and flowchart 800 may be implemented in hardware, or hardware combined with software and/or firmware. For example, score generation component 116, fraud detection component 114, data collection component 110, flowchart 500, flowchart 600, flowchart 700 and/or flowchart 800 may be implemented as computer program code/instructions configured to be executed in one or more processors and stored in a computer readable storage medium. Alternatively, score generation component 116, fraud detection component 114, data collection component 110, flowchart 500, flowchart 600, flowchart 700 and/or flowchart 800 may be implemented as hardware logic/electrical circuitry.

For instance, in an embodiment, one or more, in any combination, of score generation component 116, fraud detection component 114, data collection component 110, flowchart 500, flowchart 600, flowchart 700 and/or flowchart 800 may be implemented together in a SoC. The SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

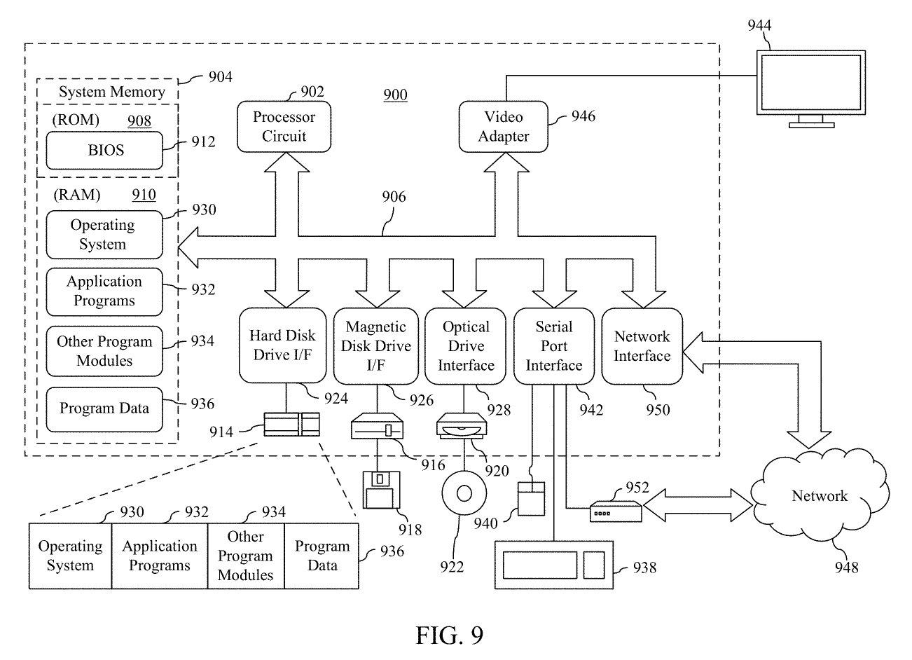

FIG. 9 depicts an exemplary implementation of a computing device 900 in which embodiments may be implemented. For example, user device(s) 102A-102N, web server/transaction processor 108 may each be implemented in one or more computing devices similar to computing device 900 in stationary or mobile computer embodiments, including one or more features of computing device 900 and/or alternative features. The description of computing device 900 provided herein is provided for purposes of illustration, and is not intended to be limiting. Embodiments may be implemented in further types of computer systems, as would be known to persons skilled in the relevant art(s).

As shown in FIG. 9, computing device 900 includes one or more processors, referred to as processor circuit 902, a system memory 904, and a bus 906 that couples various system components including system memory 904 to processor circuit 902. Processor circuit 902 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 902 may execute program code stored in a computer readable medium, such as program code of operating system 930, application programs 932, other programs 934, etc. Bus 906 represents one or more of any of several types of bus structures, including a memory bus or memory controller, a peripheral bus, an accelerated graphics port, and a processor or local bus using any of a variety of bus architectures. System memory 904 includes read only memory (ROM) 908 and random access memory (RAM) 910. A basic input/output system 912 (BIOS) is stored in ROM 908.

Computing device 900 also has one or more of the following drives: a hard disk drive 914 for reading from and writing to a hard disk, a magnetic disk drive 916 for reading from or writing to a removable magnetic disk 918, and an optical disk drive 920 for reading from or writing to a removable optical disk 922 such as a CD ROM, DVD ROM, or other optical media. Hard disk drive 914, magnetic disk drive 916, and optical disk drive 920 are connected to bus 906 by a hard disk drive interface 924, a magnetic disk drive interface 926, and an optical drive interface 928, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 930, one or more application programs 932, other programs 934, and program data 936. Application programs 932 or other programs 934 may include, for example, computer program logic (e.g., computer program code or instructions) for implementing score generation component 116, fraud detection component 114, data collection component 110, flowchart 500, flowchart 600, flowchart 700 and/or flowchart 800 (including any suitable step of said flowcharts), and/or further embodiments described herein.

A user may enter commands and information into the computing device 900 through input devices such as keyboard 938 and pointing device 940. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 902 through a serial port interface 942 that is coupled to bus 906, but may be connected by other interfaces, such as a parallel port, game port, or a universal serial bus (USB).

A display screen 944 is also connected to bus 906 via an interface, such as a video adapter 946. Display screen 944 may be external to, or incorporated in computing device 900. Display screen 944 may display information, as well as being a user interface for receiving user commands and/or other information (e.g., by touch, finger gestures, virtual keyboard, etc.). In addition to display screen 944, computing device 900 may include other peripheral output devices (not shown) such as speakers and printers.

Computing device 900 is connected to a network 948 (e.g., the Internet) through an adaptor or network interface 950, a modem 952, or other means for establishing communications over the network. Modem 952, which may be internal or external, may be connected to bus 906 via serial port interface 942, as shown in FIG. 9, or may be connected to bus 906 using another interface type, including a parallel interface.

As used herein, the terms “computer program medium,” “computer-readable medium,” and “computer-readable storage medium” are used to refer to physical hardware media such as the hard disk associated with hard disk drive 914, removable magnetic disk 918, removable optical disk 922, other physical hardware media such as RAMs, ROMs, flash memory cards, digital video disks, zip disks, MEMs, nanotechnology-based storage devices, and further types of physical/tangible hardware storage media. Such computer-readable storage media are distinguished from and non-overlapping with communication media (do not include communication media). Communication media embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media that are separate and non-overlapping with embodiments directed to computer-readable storage media.

As noted above, computer programs and modules (including application programs 932 and other programs 934) may be stored on the hard disk, magnetic disk, optical disk, ROM, RAM, or other hardware storage medium. Such computer programs may also be received via network interface 950, serial port interface 942, or any other interface type. Such computer programs, when executed or loaded by an application, enable computing device 900 to implement features of embodiments discussed herein. Accordingly, such computer programs represent controllers of the computing device 900.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Additional Example Embodiments

A fraud detection system is described herein. The fraud detection system, includes: one or more processors; and one or more memory devices accessible to the one or more processors, the one or more memory devices storing software components for execution by the one or more processors, the software components including: a data collection component configured to collect a plurality of usage attributes associated with a plurality of user actions conducted via a user account; a fraud risk score generation component configured to generate and store a first fraud risk score based at least in part on the plurality of usage attributes; the fraud risk score generation component further configured to, during a second user action conducted via the user account, retrieve the first fraud risk score, and generate a second fraud risk score based at least in part on the first fraud risk score; and a fraud detection component configured to determine if a transaction associated with the user account is fraudulent based at least on the second fraud risk score.

In one embodiment of the foregoing system, the fraud risk score generation component is configured to generate the first fraud risk score by computing at least one usage feature based on the plurality of usage attributes, and by inputting the at least one usage feature to a first machine learning model.

In another embodiment of the foregoing system, the fraud risk score generation component is configured to generate the second fraud score based also on at least one additional usage feature computed by the fraud risk score generation component after the second user action.

In another embodiment of the foregoing system, the second fraud risk score is generated by inputting the at least one additional usage feature to a second machine learning model.

In another embodiment of the foregoing system, the at least one usage feature and the at least one additional usage feature each comprise one or more of: a predetermined number of most recent device IDs used with the user account; a predetermined number of device IDs used with the user account in the past week; a predetermined number of device IDs used with the user account in the past 4 weeks; a predetermined number of most recent device IP addresses used with the user account; a predetermined number of device IP addresses used with the user account in the past week; or a predetermined number of device IP addresses used with the user account in the past 4 weeks.

In another embodiment of the foregoing system, the plurality of usage attributes are not stored during a period of time between the at least one user action and the second user action.

A computer-implemented method for detecting fraud in an online commerce system is described herein. The method includes: collecting a plurality of usage characteristics associated with a plurality of user actions conducted on the online commerce system via a user account; generating and storing a first fraud detection score based at least in part on the plurality of usage attributes; during a second user action conducted via the user account, retrieving the first fraud detection score, and generating a second fraud detection score based at least in part on the first fraud detection score; and determining if a transaction associated with the user account is fraudulent based at least in part on the second fraud detection score.

In one embodiment of the foregoing method, the plurality of usage characteristics comprise some or all of: a device identifier; a device IP address; a device IP address location; an email address; a payment instrument; a payment instrument type; a payment instrument address; an account age; a purchase history; or the frequency of use of the user account.

In one embodiment of the foregoing method, generating the first fraud detection score comprises computing at least one usage feature based on the plurality of usage attributes, and by inputting the at least one usage feature to a first machine learning model.

In one embodiment of the foregoing method, the second fraud detection score is generated based also on at least one additional usage feature computed after the second user action.

In one embodiment of the foregoing method, generating the second fraud detection score comprises inputting the at least one additional usage feature and the first fraud detection score to a second machine learning model.

In one embodiment of the foregoing method, the first and second machine learning models each comprise at least one of: a gradient boosting decision tree; an artificial neural network; or a deep neural network.

In one embodiment of the foregoing method, the at least one usage feature and the at least one additional usage feature each comprise one or more of: a predetermined number of most recent device IDs used with the user account; a predetermined number of device IDs used with the user account in the past week; a predetermined number of device IDs used with the user account in the past 4 weeks; a predetermined number of most recent device IP addresses used with the user account; a predetermined number of device IP addresses used with the user account in the past week; or a predetermined number of device IP addresses used with the user account in the past 4 weeks.

In one embodiment of the foregoing method, the plurality of user actions include at least one of: signing up for the user account; logging into the user account; or associating a payment instrument with the user account.

In one embodiment of the foregoing method, the second user action comprises at least one of: making a purchase with the user account; starting a free trial with the user account; or starting a subscription through the user account.

A computer program product comprising a computer-readable memory device having computer program logic recorded thereon that when executed by at least one processor of a computing device causes the at least one processor to perform operations is described herein. The operations include: collecting user transaction data associated with a plurality of user actions conducted via a user account; generating and storing a first fraud risk score based at least in part on the user transaction data; during a second user action conducted via the user account, retrieving the first fraud risk score, and generating a second fraud risk score based at least in part on the first fraud risk score; and determining if an action associated with the user account is abusive based at least in part on the second fraud risk score.

### V. Conclusion

While various embodiments of the present invention have been described above, it should be understood that they have been presented by way of example only, and not limitation. It will be understood by those skilled in the relevant art(s) that various changes in form and details may be made therein without departing from the spirit and scope of the invention as defined in the appended claims. Accordingly, the breadth and scope of the present invention should not be limited by any of the above-described exemplary embodiments, but should be defined only in accordance with the following claims and their equivalents.

What is claimed is:

1. A fraud detection system, comprising:
one or more processors; and
one or more memory devices accessible to the one or more processors, the one or more memory devices storing software components for execution by the one or more processors, the software components including:
a data collection component configured to collect a plurality of usage attributes associated with a plurality of user actions conducted via a user account;
a fraud risk score generation component configured to generate and store a first fraud risk score based at least in part on the plurality of usage attributes;
the fraud risk score generation component further configured to, during a second user action conducted via the user account, retrieve the first fraud risk score, and generate a second fraud risk score based at least in part on the first fraud risk score; and
a fraud detection component configured to determine if a transaction associated with the user account is fraudulent based at least on the second fraud risk score.

2. The fraud detection system of claim 1, wherein the plurality of usage attributes comprise one or more of:
a device identifier;
a device IP address;
a device IP address location;
an email address;
a payment instrument;
a payment instrument type;
a payment instrument address;
an account age;
a purchase history; or
the frequency of use of the user account.

3. The fraud detection system of claim 2, wherein the fraud risk score generation component is configured to generate the first fraud risk score by computing at least one usage feature based on the plurality of usage attributes, and by inputting the at least one usage feature to a first machine learning model.

4. The fraud detection system of claim 3 wherein the fraud risk score generation component is configured to generate the second fraud score based also on at least one additional usage feature computed by the fraud risk score generation component after the second user action.

5. The fraud detection system of claim 4, wherein the second fraud risk score is generated by inputting the at least one additional usage feature to a second machine learning model.

6. The fraud detection system of claim 5, wherein the first and second machine learning models each comprise at least one of:
a gradient boosting decision tree;
an artificial neural network; or
a deep neural network.

7. The fraud detection system of claim 3, wherein the at least one usage feature and the at least one additional usage feature each comprise one or more of:
a predetermined number of most recent device IDs used with the user account;
a predetermined number of device IDs used with the user account in the past week;
a predetermined number of device IDs used with the user account in the past 4 weeks;
a predetermined number of most recent device IP addresses used with the user account;
a predetermined number of device IP addresses used with the user account in the past week; or
a predetermined number of device IP addresses used with the user account in the past 4 weeks.

8. The fraud detection system of claim 1, wherein the plurality of user actions include at least one of:
signing up for the user account;
logging into the user account; or
associating a payment instrument with the user account.

9. The fraud detection system of claim 1, wherein the second user action comprises at least one of:
making a purchase with the user account;
starting a free trial with the user account; or
starting a subscription through the user account.

10. The fraud detection system of claim 1, wherein the plurality of usage attributes are not stored during a period of time between the at least one user action and the second user action.

11. A computer-implemented method for detecting fraud in an online commerce system, comprising:
collecting a plurality of usage characteristics associated with a plurality of user actions conducted on the online commerce system via a user account;
generating and storing a first fraud detection score based at least in part on the plurality of usage attributes;
during a second user action conducted via the user account, retrieving the first fraud detection score, and generating a second fraud detection score based at least in part on the first fraud detection score; and
determining if a transaction associated with the user account is fraudulent based at least in part on the second fraud detection score.

12. The computer-implemented method of claim 11, wherein the plurality of usage characteristics comprise some or all of:
a device identifier;
a device IP address;
a device IP address location;
an email address;
a payment instrument;
a payment instrument type;
a payment instrument address;
an account age;
a purchase history; or
the frequency of use of the user account.

13. The computer-implemented method of claim 12, wherein generating the first fraud detection score comprises computing at least one usage feature based on the plurality of usage attributes, and by inputting the at least one usage feature to a first machine learning model.

14. The computer-implemented method of claim 13 wherein the second fraud detection score is generated based also on at least one additional usage feature computed after the second user action.

15. The computer-implemented method of claim 14, wherein generating the second fraud detection score comprises inputting the at least one additional usage feature and the first fraud detection score to a second machine learning model.

16. The computer-implemented method of claim 15, wherein the first and second machine learning models each comprise at least one of:
a gradient boosting decision tree;
an artificial neural network; or
a deep neural network.

17. The computer-implemented method of claim 13, wherein the at least one usage feature and the at least one additional usage feature each comprise one or more of:
a predetermined number of most recent device IDs used with the user account;
a predetermined number of device IDs used with the user account in the past week;
a predetermined number of device IDs used with the user account in the past 4 weeks;
a predetermined number of most recent device IP addresses used with the user account;
a predetermined number of device IP addresses used with the user account in the past week; or
a predetermined number of device IP addresses used with the user account in the past 4 weeks.

18. The computer-implemented method of claim 11, wherein the plurality of user actions include at least one of:
signing up for the user account;
logging into the user account; or
associating a payment instrument with the user account.

19. The computer-implemented method of claim 11, wherein the second user action comprises at least one of:
making a purchase with the user account;
starting a free trial with the user account; or
starting a subscription through the user account.

20. A computer program product comprising a computer-readable memory device having computer program logic recorded thereon that when executed by at least one processor of a computing device causes the at least one processor to perform operations, the operations comprising:
collecting user transaction data associated with a plurality of user actions conducted via a user account;
generating and storing a first fraud risk score based at least in part on the user transaction data;
during a second user action conducted via the user account, retrieving the first fraud risk score, and generating a second fraud risk score based at least in part on the first fraud risk score; and
determining if an action associated with the user account is abusive based at least in part on the second fraud risk score.
